(19) United States
(12) Patent Application Publication
(10) Pub. No.: US 2008/0269441 A1
(43) Pub. Date: Oct. 30, 2008

(54) Polymerization process providing polyethylene of enhanced optical properties

(76) Inventors: Gerhard Guenther, Seabrook, TX (US); David W. Knoeppel, League City, TX (US); Steven D. Gray, Bellaire, TX (US); Tim J. Coffy, Houston, TX (US)

Correspondence Address: FINA TECHNOLOGY INC, PO BOX 674412, HOUSTON, TX, 77267-4412, US

(21) Appl. No.: 11/796,888

(22) Filed: Apr. 30, 2007

(51) Int. Cl. C08F 4/44

(52) U.S. Cl. 526/134

(57) ABSTRACT

A process for the polymerization of ethylene to provide an ethylene polymer of reduced Yellowness Index. A feed stream, comprising an inert hydrocarbon diluent containing ethylene in a minor amount, is supplied to a polymerization reactor. A chromium-based polymerization catalyst and a triethylboron co-catalyst are incorporated into the feed stream within the reactor. The polymerization catalyst will normally be used in an amount within the range of 0.008-0.1 wt. % of the diluent in the feed stream and the triethylboron co-catalyst is incorporated in an amount within the range of 0.1-50 ppm of the diluent. The polymer fluff from the reactor is heated to a temperature sufficient to melt the fluff which is then extruded to produce a polymer product. The Yellowness Index after high temperature aging is at least 5% less than the corresponding Yellowness Index of a corresponding polymer product produced without the triethylboron co-catalyst.

### FIELD OF THE INVENTION

This invention relates to the polymerization of ethylene to produce ethylene homopolymers and copolymers with a chromium-based polymerization catalyst in the presence of triethylboron co-catalyst under conditions to provide a polymer product of good optical properties while retaining good mechanical or physical properties.

### BACKGROUND OF THE INVENTION

Polyethylene as a homopolymer or an ethylene alpha olefin copolymer can be employed in a number of commercial applications in which good visual or optical properties are important. For example, polyethylene may be employed in the production of various products such as bottles or other containers and the like which can be produced by blow molding or extrusion molding operations. In such applications, it is desirable to arrive at a product having good optical characteristics in which a desired color is maintained without extensive yellowing of the bottle or other container with time. The resistance of a polymer product to yellowing with time can be measured by the Yellowness Index (YI) as determined in accordance with American Society for Testing Material Standard ASTM-D1925. As understood by those skilled in the art, an increase in the Yellowness Index with time is a measure of the undesirable discoloration of the polymer product.

Other significant physical characteristics of polyethylene polymers include the molecular weight distribution, MWD (a ratio of the weight average molecular weight, M_{w}, to the number average molecular weight, Mₙ), and shear response as determined by the ratio of melt indices as determined in accordance with standard ASTM D1238. Thus, the shear response, SR2, is characterized as a ratio of the high load melt index (HLMI) to the melt index MI₂ and the shear response, SR5, is the ratio of the high load melt index to the melt index MI₅. The various melt indices are conventionally reported in terms of melt flows in grams/10 minutes (g/10 min.) or the equivalent measure as expressed in terms of decigrams/minute (dg/min.).

The polymer fluff withdrawn from the polymerization reactor is typically separated from the diluent in which the polymerization reaction proceeds, and then melted and extruded to produce particles of the polymer product, typically in the nature of pellets having dimensions of about ⅛″-¼″ which then are ultimately used to produce the polyethylene containers or other commercial products. During the extrusion process, stabilizing agents may be incorporated into the polymer. Such stabilizing agents typically include phenolic antioxidants, such as sterically-hindered phenols and phosphite antioxidants. Other polymer characteristics which are significant in terms of suitability of the polymer for the end product include resistance to mechanical failure as measured by notched constant ligament stress (NCLS) and environmental stress crack resistance (ESCR) as determined in accordance with American Society Testing Standard ASTM D1693.

### SUMMARY OF THE INVENTION

In accordance with the present invention, there is provided a process for the polymerization of ethylene to provide an ethylene homopolymer or copolymer of a reduced Yellowness Index. In carrying out the invention, a feed stream, comprising an inert hydrocarbon diluent containing ethylene, and optionally a higher alpha olefin comonomer, is supplied to a polymerization reaction zone. The feed stream is composed primarily of the inert hydrocarbon diluent, such as a normally liquid alkane or an aromatic compound, with the ethylene being present in a minor amount, usually no more than 10 wt. % of the diluent. The higher molecular weight alpha olefin comonomer, if present, will be employed in an amount that is less than the amount of the ethylene in the feed stream. Hydrogen may also be supplied to the polymerization reaction zone.

A chromium-based polymerization catalyst and a triethylboron co-catalyst are incorporated into the feed stream within the polymerization reactor. The polymerization catalyst will normally be used in an amount within the range of 0.008-0.1 wt. % of the diluent in the feed stream and the triethylboron co-catalyst will be incorporated in an amount within the range of 0.1-50 parts per million (ppm) of the diluent. The catalyst and the co-catalyst may be supplied separately or mixed and supplied either continuously or intermittently to the feed stream as it is fed into the polymerization reactor. The polymerization reaction zone is operated under polymerization conditions to produce an ethylene polymer fluff by the polymerization or co-polymerization of the ethylene monomer. The polymer fluff is withdrawn from the polymerization reaction zone and then heated to a temperature sufficient to melt the fluff for extrusion. The melted fluff is then extruded to produce particles of the ethylene homopolymer or copolymer. In accordance with the invention, the reaction zone is operated under conditions effective to produce a polymer product, which has a reduced Yellowness Index (YI) than would be the case where the chromium-based polymerization catalyst is employed without the addition of the triethylboron co-catalyst. Specifically, the polymer product resulting from the extrusion of the fluff has a Yellowness Index after aging at a temperature of 175° F. for 60 hours, which is at least 5% less than the corresponding Yellowness Index of the polymer product produced without the use of the triethylboron co-catalyst.

In a further aspect of the invention, the polymer product is a copolymer of ethylene and a C₃-C₈ olefin, more specifically, hexene. The hexene, or other higher molecular weight olefin, may be employed in a concentration that is less than 50 wt. % of the concentration of the ethylene in the feed stream. In one embodiment of the invention, the triethylboron co-catalyst is incorporated into the feed stream in an amount effective to increase the activity of the polymerization catalyst by an amount which is at least 10% greater than the activity of the catalyst without the addition of the triethylboron co-catalyst. In yet a further aspect of the invention, the triethylboron co-catalyst is employed in the feed stream in an amount to produce a polymer product having a broader molecular weight distribution than the molecular weight distribution of the corresponding polymer product produced without the addition of the triethylboron co-catalyst.

### BRIEF DESCRIPTION OF THE DRAWINGS

FIG. 1 is a schematic illustration of a process for the polymerization of ethylene and a comonomer in which the present invention is implemented.

FIG. 2 is a graphical illustration of heat-aged Yellowness Index values for a polymer product produced in accordance with the present invention.

FIG. 3 is a graphical representation of heat aging Yellowness Index data illustrating the change in Yellowness Index for polymer products employed in accordance with the present invention.

### DETAILED DESCRIPTION OF THE INVENTION

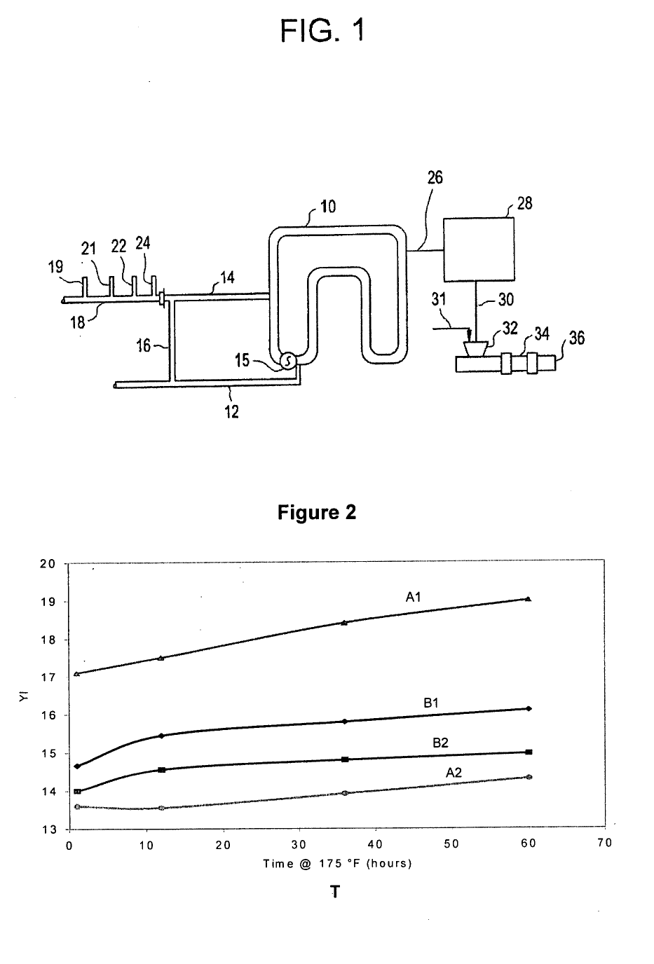

The invention will be described with reference to a loop-type reactor used in the production of ethylene homopolymers or copolymers. Referring to FIG. 1, there is illustrated a loop-type polymerization reactor 10 which is supplied with a feed stream comprising a diluent and ethylene monomer through an input line 12 and a catalyst system through an input line 14. The continuous loop-type reactor is, as will be understood by those skilled in the art, equipped with an impeller 15 which functions to circulate the polymerization reaction mass continuously through the loop-type reactor under controlled temperature and pressure conditions. The polymerization reactor may be operated under any suitable conditions. Liquefied isobutane may be used as the diluent medium in the course of the polymerization reaction within reactor 10. Alternatively, a higher molecular weight diluent such as hexane can be used.

The catalyst and co-catalyst may be introduced into the polymerization reactor by any suitable technique. In one mode of operation, the catalyst system may be introduced into the reactor employing a catalyst injection system of a type often employed for Phillips-type silica supported chromium catalysts. In this mode of application a catalyst system, comprising a chromium-based polymerization catalyst as described previously and a triethylboron (TEB) co-catalyst, is incorporated into the polymerization reactor through catalyst feed line 14. In the catalyst injection system, a diluent, such as isobutane, is supplied to a mixing line 18 via a supply line 19. The TEB co-catalyst is supplied through line 21 and the chromium-based catalyst is introduced through line 22, and the catalyst system is then introduced into the reactor 10 via line 14. Alternatively or in addition to introduction through line 14, the catalyst system may be passed through line 16 to line 12 for introduction to reactor 10. The catalyst may be supplied either continuously or intermittently to the carrier stream for introduction into the reactor. The catalyst may be prepolymerized prior to introduction into the polymerization reactor 10. For example, the chromium based catalyst and the TEB cocatalyst may be polymerized in a tubular reactor prior to introduction into the reactor, as described in U.S. Pat. No. 4,767,735 to Ewen et al. For a further description of suitable prepolymerization procedures which may be employed in carrying out the invention, reference is made to the aforementioned patent U.S. Pat. No. 4,767,735, the entire disclosure of which is incorporated herein by reference. In another mode of operation, the chromium-based catalyst and the TEB co-catalyst may be introduced into the polymerization reactor through separate feed lines. For example, referring to FIG. 1, the chromium-based catalyst may be introduced into the reactor through line 14 (without pre-mixing with the co-catalyst) and the TEB co-catalyst is introduced into the reactor through a separate line 24. The separate line 24 may be located upstream or downstream of the point of introduction of the chromium-based catalyst through line 14. As indicated in the drawing, a suitable location of the separate line 24 is upstream of line 14 and provides for the introduction of the TEB co-catalyst into the reactor shortly after introduction of the chromium-based polymerization catalyst.

At the product side of the reactor, the ethylene homopolymer or copolymer is withdrawn via line 26. Typically, a deactivator is incorporated into the product stream in order to terminate the polymerization reaction in the solvent stream containing the polyethylene. The product is supplied through line 26 to a concentration and recovery system 28 in which polyethylene fluff is extracted. Diluent and unreacted ethylene are recovered through a suitable purification and recovery system (not shown) and recycled to the reactor 10. The product stream containing the polyethylene fluff, which is now free of gaseous ethylene, is withdrawn from the recovery system via line 30.

The polyethylene fluff is supplied to the input hopper 32 of an extruder-die system 34. Stabilization additives are supplied to the hopper 32 through line 31. In the extruder-die system, the polymer is heated to a molten state, and the molten polymer is extruded and then cut into appropriate particles. Typically, the polyethylene product may be extruded and die cut into pellets which are discharged from the product end 36 of the extruder-die system 34. These pellets may then be heated and extruded and molded in various applications, such as in the production of bottles or other polyethylene products.

The chromium-based catalyst employed in carrying out the present invention may be of any suitable type that is effective in the polymerization or copolymerization of ethylene. Typically the chromium-based catalyst will incorporate a silica support and have a chromium content of ranging to ½ weight % to 5 weight % chromium. The chromium-based catalyst may also include titanium which normally will be present in the amount of 1-5 weight %. Suitable chromium-based catalysts which may be employed in carrying out the present invention are disclosed in U.S. Pat. No. 6,423,663 to Debras and U.S. Pat. No. 6,489,428 to Debras, et al, the entire disclosures of which are incorporated herein by reference.

In experimental work respecting the present invention, ethylene homopolymers and ethylene-hexene copolymers were produced in standard laboratory polymerization runs to produce the corresponding polymer fluff. In each case, the polymer fluff was stabilized by the addition to the fluff during extrusion to form pellets of a stabilized package having 400 ppm of a phenolic antioxidant identified as Irgonox 1010 and 1,600 ppm of a phosphite antioxidant identified as Irgafos 168. After extrusion to form the polymer pellets, the pellets were heat aged under standard conditions for 60 hours with the Yellowness Index numbers determined at approximately 12, 36 and 60 hours.

The catalysts employed in the experimental work were commercially available chromium-based catalysts and are identified herein as Catalysts A, B, and C, characterized by a chromium content of about 1.0 wt. % for each catalyst. Catalysts A, B and C also contained titanium in respective amounts of 2.4, 2.3 and 3.7 weight % titanium. In the laboratory polymerization runs, polymerization was carried out without a co-catalyst and with triethylboron as a co-catalyst in amounts ranging from 4-12 ppm of the diluent. The diluent used was isobutane. The ethylene was used in the polymerization runs in a concentration of 8 wt. % of the isobutane diluent and for the copolymers, the comonomer 1-hexene was used in a concentration of up to 72 wt. %. The polymerization or copolymerization runs were carried out in a bench reactor at temperatures ranging from 94 to 104° C. The catalysts were activated at an activation temperature of about 1,100° F.

The homopolymer or copolymer fluff recovered from the polymerization reactor was blended with the antioxidant additive package identified above and for the color studies then extruded into pellets to produce polymer products identified herein as products PA, PB and PC, corresponding respectively to the catalyst used as identified above as catalysts A, B an C in the polymerization runs.

In one set of experiments, ethylene homopolymer was produced without the TEB co-catalyst and with the TEB co-catalyst at concentrations of 4, 8 and 12 ppm to produce homopolymer polymers PA, PB and PC. The activities of the catalyst in grams of polymer per grams of catalyst per hour for runs varying from 0 ppm TEB up to 12 ppm TEB are set forth in Table I.

TABLE I
CATALYST ACTIVITY VERSUS TEB CONCENTRATION

TEB Concentration

| | 0 | 4 | 8 | 12 |
|---|---|---|---|---|
| Catalyst A | 1409 | 2475 | 2452 | 2714 |
| Catalyst B | 1452 | 2315 | 3178 | 2659 |
| Catalyst C | 905 | 3531 | 3749 | 2029 |

The melt flow values of MI₂, MI₅ and HLMI as a function of the various triethylboron concentrations for the polymer products PA, PB, and PC are set forth in Tables II-IV.

TABLE II
MI₂ VERSUS TEB CONCENTRATION

TEB Concentration

| | 0 | 4 | 8 | 12 |
|---|---|---|---|---|
| Polymer PA | 0.24 | 0.13 | 0.15 | 0.15 |
| Polymer PB | 0.27 | 0.11 | 0.12 | 0.09 |
| Polymer PC | 0.41 | 0.22 | 0.30 | 0.27 |

TABLE III
MI₅ VERSUS TEB CONCENTRATION

TEB Concentration

| | 0 | 4 | 8 | 12 |
|---|---|---|---|---|
| Polymer PA | 0.91 | 0.67 | 0.68 | 0.94 |
| Polymer PB | 2.04 | 0.65 | 0.74 | 0.68 |
| Polymer PC | 1.61 | 1.21 | 1.37 | 1.22 |

TABLE IV
HLMI VERSUS TEB CONCENTRATION

TEB Concentration

| | 0 | 4 | 8 | 12 |
|---|---|---|---|---|
| Polymer PA | 16.4 | 12.4 | 15.2 | 19.0 |
| Polymer PB | 19.4 | 12.3 | 13.20 | 15.0 |
| Polymer PC | 22.0 | 22.8 | 26.4 | 26.1 |

The shear ratios SR2 (HLMI/MI₂) and SR5 (HLMI/MI₅) for the polymer products are set forth in Tables V and VI.

TABLE V
SR2 VERSIS TEB CONCENTRATION

TEB Concentration

| | 0 | 4 | 8 | 12 |
|---|---|---|---|---|
| Polymer PA | 68 | 95 | 101 | 127 |
| Polymer PB | 72 | 112 | 110 | 167 |
| Polymer PC | 54 | 104 | 88 | 97 |

TABLE VI
SR5 VERSUS TEB CONCENTRATION

TEB Concentration

| | 0 | 4 | 8 | 12 |
|---|---|---|---|---|
| Polymer PA | 18.0 | 18.5 | 22.4 | 20.2 |
| Polymer PB | 9.5 | 18.9 | 17.8 | 22.1 |
| Polymer PC | 13.7 | 18.8 | 19.3 | 21.4 |

As can be seen from an examination of the data in Tables I-VI, the low levels of the TEB used have a significant effect on polymerization kinetics. For Catalyst A, the catalyst showed a maximum or a near maximum activity at 4 ppm of TEB with roughly the same activity shown at 8 ppm TEB with a slightly increased activity at 12 ppm TEB. For Catalysts B and C, the greatest activities occurred in the 4-8 ppm TEB range and then decreased somewhat at the highest level tested, 12 ppm TEB. As indicated in Tables V and VI, the shear ratios SR2 and SR5 were generally increased by the addition of the TEB co-catalyst throughout the 4-12 ppm range tested.

In further experimental work, copolymers were produced employing hexene as the comonomer in concentrations of 0.18 wt. % and 0.36 wt. % in the diluent. In this experimental work, the TEB concentration was held constant at 4 ppm. The same antioxidant additive package as described above was added to the polymer fluff during the extrusion procedure. The values of MI₂, MI₅ and the high load melt index, HLMI, corresponding to the various hexene concentrations are set forth in Tables VII, VIII and IX, respectively.

TABLE VII
MI₂ VERSUS HEXENE CONCENTRATION

| | Weight Percent | | |
|---|---|---|---|
| | Hexene | | |
| | 0 | 0.18 | 0.36 |
| Copolymer A | 0.13 | 0.27 | 0.29 |
| Copolymer B | 0.11 | 0.17 | 0.25 |
| Copolymer C | 0.22 | 0.35 | 0.42 |

TABLE VIII
MI₅ VERSUS HEXENE CONCENTRATION

| | Weight Percent | | |
|---|---|---|---|
| | Hexene | | |
| | 0 | 0.18 | 0.36 |
| Copolymer A | 0.67 | 0.88 | 1.32 |
| Copolymer B | 0.65 | 0.90 | 1.23 |
| Copolymer C | 1.21 | 1.51 | 1.75 |

TABLE IX
HLMI VERSUS HEXENE CONCENTRATION

| | Weight Percent | | |
|---|---|---|---|
| | Hexene | | |
| | 0 | 0.18 | 0.36 |
| Copolymer A | 12.4 | 14.2 | 18.2 |
| Copolymer B | 12.3 | 14.8 | 16.7 |
| Copolymer C | 22.8 | 23.5 | 25.8 |

The resulting shear ratio values of SR2 and SR5 for the polymer products A, B and C are set forth in Tables X and XI.

TABLE X
SR2 AS A FUNCTION OF HEXENE CONCENTRATION

| | Weight Percent | | |
|---|---|---|---|
| | Hexene | | |
| | 0 | 0.18 | 0.36 |
| Copolymer A | 95 | 53 | 63 |
| Copolymer B | 112 | 87 | 67 |
| Copolymer C | 104 | 67 | 61 |

TABLE XI
SR5 AS A FUNCTION OF HEXENE CONCENTRATION

| | Weight Percent | | |
|---|---|---|---|
| | Hexene | | |
| | 0 | 0.18 | 0.36 |
| Copolymer A | 18.5 | 16.1 | 13.8 |
| Copolymer B | 18.9 | 16.4 | 13.6 |
| Copolymer C | 18.8 | 15.6 | 14.6 |

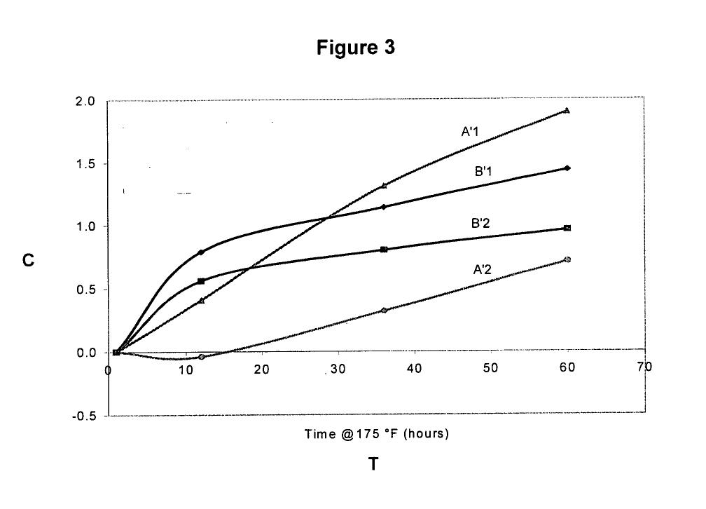

In further experimental work to determine the color integrity of polymer products polymerized employing triethylboron as a co-catalyst, color integrity studies were carried out on ethylene-hexene co-polymers polymerized with the chromium-based catalysts identified above as Catalysts A and B without the addition of triethylboron and with the triethylboron added to the isobutene diluent in an amount of 4 ppm. The ethylene monomer was added to the diluent in the polymerization system in an amount of 4-8 wt. %. The hexene comonomer was added to the diluent in an amount of up to 0.72 wt. %. The fluff recovered from the laboratory polymerization reactor was extruded after stabilization of the fluff with the additive package described above, 400 ppm of the phenolic antioxidant Irgonox 1010 and 1,600 ppm of the phosphite antioxidant Irgafos 168. After recovery of the pelletized polymer products from the extrusion system, they were aged at a temperature of 175° F. for a period of 60 hours. In the course of the aging studies, Yellowness Index values of the polymer products were measured at times of approximately 12 hours, 36 hours and 60 hours. The Yellowness Index values were determined in accordance with American Society for Testing Materials Standards ASTM-D1925. The experimental work uniformly showed a reduction in the Yellowness Index of the polymer product through the use of the triethylboron as a co-catalyst. The results of this experimental work are illustrated in FIGS. 2 and 3. In FIG. 2, the Yellowness Index (YI) for the copolymers produced by Catalysts A and B as described above is plotted on the ordinate, versus the time, T in hours, plotted on the abscissa. The Yellowness Index values for the copolymer produced by Catalyst A without the addition of triethylboron is indicated by curve A1 and the Yellowness Index of the corresponding copolymer produced employing 4 ppm TEB is indicated by curve A2. Similarly, the Yellowness Index for the copolymer produced by Catalyst B without the use of TEB is indicated by curve B1 and the corresponding copolymer product produced employing 4 ppm TEB is indicated by curve B2.

As can be seen from an examination of the data presented in FIG. 2, the use of the triethylboron co-catalyst consistently produced a reduction in Yellowness Index over the time of the aging study. The greatest reduction in Yellowness Index was observed for the copolymer produced by Catalyst A with the catalyst system incorporating the TEB co-catalyst showing a reduction of approximately 25% at 60 hours of aging. While the effect was not as pronounced for the copolymer produced using Catalyst B, the polymer products produced using this catalyst also showed significant improvements in Yellowness Index with a reduction of about 8%, observed at an aging time of 60 hours, with Catalyst B showing a relatively modest increase in Yellowness Index across the time of the aging studies.

FIG. 3 illustrates the effect of the heat aging study on Yellowness Index values presented in terms of the change in the Yellowness Index, C, plotted on the ordinate, versus the aging time, plotted on the abscissa. In FIG. 3, the change in Yellowness Index for the copolymer A without the addition of the triethylboron is indicated by curve A′1, and the change in Yellowness Index for the polymer product produced by Catalyst A and the co-catalyst triethylboron is indicated by curve A′2. Similar values for the copolymer produced by Catalyst B are indicated by curve B′1 where no TEB co-catalyst was employed, and curve B′2 where the catalyst system included 4 ppm TEB. As illustrated by the data presented in FIG. 3, the increase in the yellowness with age was again substantially retarded through the use of the triethylboron co-catalyst.

As indicated by the foregoing experimental work, the use of a triethylboron co-catalyst in accordance with the present invention enables the production of polymers of reduced Yellowness Index and improved aging characteristics in terms of Yellowness Index, while at the same time providing for enhanced catalyst activity and improved polymer characteristics.

Having described specific embodiments of the present invention, it will be understood that modifications thereof may be suggested to those skilled in the art, and it is intended to cover all such modifications as fall within the scope of the appended claims.

1. A process for the polymerization of ethylene to provide an ethylene polymer having a reduced Yellowness Index (YI) comprising:
(a) supplying a feed stream comprising an inert hydrocarbon diluent containing a minor amount of ethylene to a polymerization reaction zone;
(b) incorporating a chromium-based polymerization catalyst into said feed stream within the polymerization reaction zone;
(c) incorporating a triethylboron co-catalyst in an amount within the range of 0.1-50 ppm based upon said diluent into said feed stream within the polymerization reaction zone;
(d) operating said reaction zone under polymerization conditions to produce a polyethylene polymer fluff by polymerization of said ethylene monomer;
(e) withdrawing said polyethylene polymer fluff from said reaction zone;
(f) heating said polyethylene polymer fluff to a temperature sufficient to melt said fluff and thereafter extruding said heated polymer fluff to produce pellets of said polyethylene polymer; and
(g) operating said reaction zone under conditions effective to produce a polymer product resulting from heating and extrusion of said polymer fluff which has a Yellowness Index after aging at an elevated temperature which is at least 5% less than the corresponding Yellowness Index of a corresponding polymer product produced under the identical polymerization conditions in which said polyethylene fluff is produced, but without the addition of said triethylboron co-catalyst.

2. The process of claim 1 wherein said polymer product exhibits a change in Yellowness Index after aging at an elevated temperature which is less than the change in Yellowness Index of the corresponding polymer product after aging under the same conditions.

3. The process of claim 1 wherein polyethylene polymer fluff is a polyethylene homopolymer.

4. The process of claim 1 wherein a higher molecular weight olefin having a molecular weight greater than the molecular weight of ethylene is incorporated into said feed stream and operating said reaction zone under said polymerization conditions to produce a co-polymer of ethylene and said higher molecular weight olefin.

5. The process of claim 4 wherein said higher molecular weight olefin is a C₃-C₈ olefin.

6. The process of claim 5 wherein said higher molecular weight olefin is hexene in a concentration which is less than 50 wt. % of the concentration of ethylene in said feed stream.

7. The process of claim 1 wherein said triethylboron co-catalyst is incorporated into said feed stream in an amount to produce a polymer product having a molecular weight distribution which is broader than the molecular weight distribution of a corresponding polymer product produced under the identical polymerization conditions in which said polyethylene fluff is produced, but without the addition of said triethylboron co-catalyst.

8. The process of claim 1 wherein said triethylboron co-catalyst is incorporated into said feed stream in an amount effective to provide a polymer product having a shear response, SR2, which is greater than the shear response, SR2, of a corresponding polymer product produced under the identical polymerization conditions in which said polyethylene fluff is produced, but without the addition of said triethylboron co-catalyst.

9. The process of claim 1 wherein said triethylboron co-catalyst is incorporated into said feed stream in an amount effective to provide a polymer product having a shear response, SR5, which is greater than the shear response, SR5, of a corresponding polymer product produced under the identical polymerization conditions in which said polyethylene fluff is produced, but without the addition of said triethylboron co-catalyst.

10. The process of claim 1 wherein said triethylboron co-catalyst is incorporated into said feed stream in an amount to increase the activity of said polymerization catalyst for the production of said polymer fluff by an amount which is at least 10% greater than the activity of said catalyst under the identical polymerization conditions, but without the addition of said triethylboron co-catalyst.

11. A process for the polymerization of ethylene to provide an ethylene polymer having a reduced Yellowness Index (YI) comprising:
(a) supplying a feed stream comprising an inert hydrocarbon diluent containing a minor amount of ethylene to a polymerization reaction zone;
(b) incorporating a chromium-based polymerization catalyst in an amount within the range of 0.008-0.1 wt. % into said feed stream within the polymerization reaction zone;
(c) incorporating a triethylboron co-catalyst in an amount within the range of 0.1-50 ppm based upon said diluent into said feed stream within the polymerization reaction zone;
(d) operating said reaction zone under polymerization conditions to produce a polyethylene polymer fluff by polymerization of said ethylene monomer;
(e) withdrawing said polyethylene polymer fluff from said reaction zone;
(f) heating said polyethylene polymer fluff to a temperature sufficient to melt said fluff and thereafter extruding said heated polymer fluff to produce pellets of said polyethylene polymer; and
(g) operating said reaction zone under conditions effective to produce a polymer product resulting from heating and extrusion of said polymer fluff which has a Yellowness Index after aging at a temperature of 175° F. for 60 hours, which is at least 5% less than the corresponding Yellowness Index of a corresponding polymer product produced under the identical polymerization conditions in which said polyethylene fluff is produced, but without the addition of said triethylboron co-catalyst.

12. The process of claim 11 wherein said polymer product exhibits a change in Yellowness Index with time after aging at 175° F. which is less than the change in Yellowness Index of the corresponding polymer product after aging under the same conditions.

13. The process of claim 11 wherein polyethylene polymer fluff is a polyethylene homopolymer.

14. The process of claim 11 wherein an olefin having a molecular weight greater than the molecular weight of ethylene is incorporated into said feed stream and operating said reaction zone under said polymerization conditions to produce a co-polymer of ethylene and said higher molecular weight olefin.

15. The process of claim 14 wherein said higher molecular weight olefin is a C₃-C₈ olefin.

16. The process of claim 15 wherein said higher molecular weight olefin is hexene in a concentration which is less than 50 wt. % of the concentration of ethylene in said feed stream.

17. The process of claim 11 wherein said triethylboron co-catalyst is incorporated into said feed stream in an amount to produce a polymer product having a molecular weight distribution which is broader than the molecular weight distribution of a corresponding polymer product produced under the identical polymerization conditions in which said polyethylene fluff is produced, but without the addition of said triethylboron co-catalyst.

18. The process of claim 11 wherein said triethylboron co-catalyst is incorporated into said feed stream in an amount effective to provide a polymer product having a shear response, SR2, which is greater than the shear response, SR2, of a corresponding polymer product produced under the identical polymerization conditions in which said polyethylene fluff is produced, but without the addition of said triethylboron co-catalyst.

19. The process of claim 11 wherein said triethylboron co-catalyst is incorporated into said feed stream in an amount effective to provide a polymer product having a shear response, SR5, which is greater than the shear response, SR5, of a corresponding polymer product produced under the identical polymerization conditions in which said polyethylene fluff is produced, but without the addition of said triethylboron co-catalyst.

20. The process of claim 11 wherein said triethylboron co-catalyst is incorporated into said feed stream in an amount to increase the activity of said polymerization catalyst for the production of said polymer fluff by an amount which is at least 10% greater than the activity of said catalyst under the identical polymerization conditions, but without the addition of said triethylboron co-catalyst.
